(19) United States
(12) Patent Application Publication
(10) Pub. No.: US 2025/0205861 A1
(43) Pub. Date: Jun. 26, 2025

(54) Torque Measurement with Increased Accuracy at Lower Torque Values

(71) Applicant: Apex Brands, Inc., Apex, NC (US)

(72) Inventors: Bin Sun, Shanghai (CN); Henglian Luo, Shanghai (CN); Tong Li, Shanghai (CN)

(21) Appl. No.: 18/846,046

(22) PCT Filed: Mar. 17, 2022
(86) PCT No.: PCT/CN2022/081517

§ 371 Date: Sep. 11, 2024

(51) Int. Cl. B25B 23/142; G01L 25/00

(52) U.S. Cl. CPC B25B 23/1425; G01L 25/003

(57) ABSTRACT

An apparatus (200) such as an electronic torque wrench (100) is provided that includes an amplifier (204), analog-to-digital converter (206) and processing circuitry (208). The amplifier (204) is configured to receive an analog electrical signal that varies in voltage with an applied torque, and increase amplitude of the analog electrical signal to produce an amplified, analog electrical signal. The amplifier (204) has a gain that is controllable and set based on a measured torque. The analog-to-digital converter (206) is configured to convert the amplified, analog electrical signal to an equivalent digital electrical signal. And the processing circuitry (208) is configured to determine the torque value of the torque applied to the fastener from the equivalent digital electrical signal, and output an indication of the torque value. A method of determining a torque value of an applied torque is also provided.

### TECHNOLOGICAL FIELD

The present disclosure relates generally to torque application and measurement devices and, in particular, to an apparatus for torque measurement such as an electronic torque wrench.

### BACKGROUND

Fasteners are often used to assemble performance critical components are tightened to a specified torque level to introduce a “pretension” in the fastener. As torque is applied to the head of the fastener, the fastener may begin to stretch beyond a certain level of applied torque. This stretch results in the pretension in the fastener which then holds the components together. Additionally, it is often necessary to further rotate the fastener through a specified angle after the desired torque level has been applied. A popular method of tightening these fasteners is to use a torque wrench.

Torque wrenches may be of mechanical or electronic type. Mechanical torque wrenches are generally less expensive than electronic. There are two common types of mechanical torque wrenches, beam and clicker types. In a beam type torque wrench, a beam bends relative to a non-deflecting beam in response to applied torque. The amount of deflection of the bending beam relative to the non-deflecting beam indicates the amount of torque applied to the fastener. Clicker type torque wrenches have a selectable preloaded snap mechanism with a spring to release at a specified torque, thereby generating a click noise.

Electronic torque wrenches tend to be more expensive than mechanical torque wrenches. When applying torque to a fastener with an electronic torque wrench, the torque readings indicated on the display device of the electronic torque wrench relate to the pretension in the fastener due to the applied torque.

Many electronic torque wrenches have a rated torque range over which the electronic torque wrenches are designed to provide its most accurate torque readings. In this regard, an electronic torque wrench that has a rated torque range of 20% to 100% of a preset maximum torque may provide torque readings with a tolerance of ±1% within the rated torque range. When the preset maximum torque is 100 N·m, the electronic torque wrench may provide torque readings with a tolerance of ±0.2 N·m to ±1 N·m in the rated torque range of 20 N·m to 100 N·m. The electronic torque wrench may still provide torque readings below the rated torque range, but often with decreased accuracy (and correspondingly increased tolerance).

It would therefore be desirable to have a system and method that takes into account at least some of the issues discussed above, as well as other possible issues.

### BRIEF SUMMARY

Example implementations of the present disclosure are directed to an apparatus such as an electronic torque wrench for torque measurement with increased accuracy at lower torque values. The present disclosure includes, without limitation, the following example implementations.

Some example implementations provide an apparatus for determining a torque value of an applied torque, the apparatus comprising: an amplifier configured to receive an analog electrical signal that varies in voltage with the applied torque, and increase an amplitude of the analog electrical signal to produce an amplified, analog electrical signal, the amplifier having a gain that is controllable and set based on a measured torque; an analog-to-digital converter configured to convert the amplified, analog electrical signal to an equivalent digital electrical signal; and processing circuitry configured to determine the torque value of the torque applied to the fastener from the equivalent digital electrical signal, and output an indication of the torque value.

Some example implementations provide a method of determining a torque value of an applied torque, the method comprising: receiving an analog electrical signal that varies in voltage with the applied torque; applying the analog electrical signal to an amplifier that increases an amplitude of the analog electrical signal to produce an amplified, analog electrical signal, the amplifier having a gain that is controllable and set based on a measured torque; converting the amplified, analog electrical signal to an equivalent digital electrical signal using an analog-to-digital converter; and determining the torque value of the torque applied to the fastener from the equivalent digital electrical signal; and outputting an indication of the torque value.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIGS. 1A and 1B illustrate an electronic torque wrench, according to some example implementations of the present disclosure;

FIG. 2 is a block diagram of an apparatus for determining a torque value of an applied torque, and that may correspond to the electronic torque wrench of FIG. 1, according to some example implementations;

FIGS. 3A, 3B and 3C are graphs of linear functions from which a calibration function may be selected for use to convert digital values of equivalent digital electrical signals into equivalent torque values, according to some example implementations; and

FIGS. 4A, 4B, 4C, 4D, 4E, 4F and 4G are flowcharts illustrating various steps in a method of determining a torque value of an applied torque, according to example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

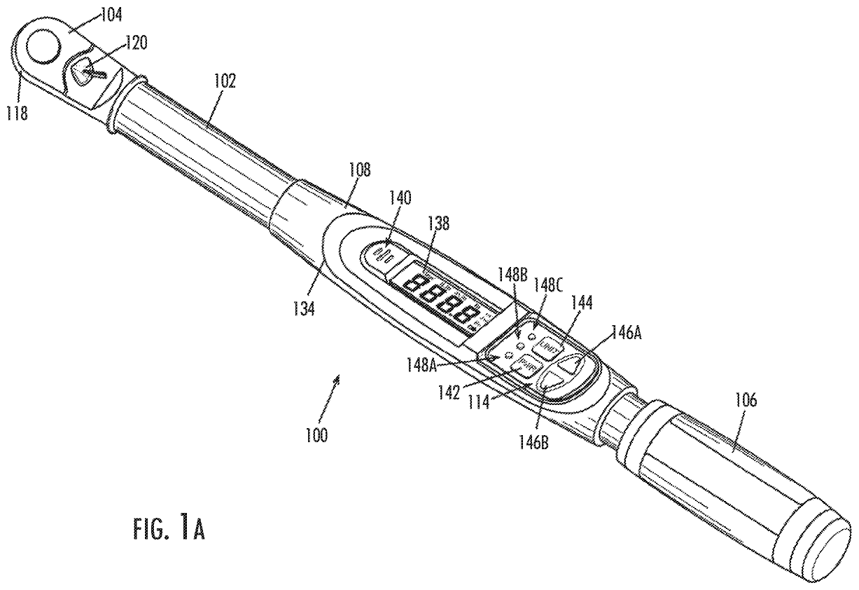

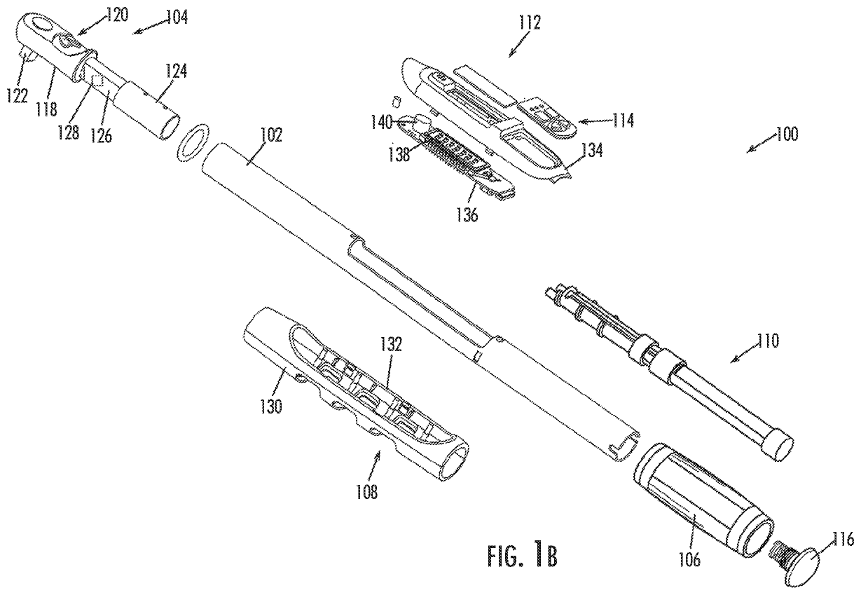

Example implementations of the present disclosure relate generally to torque application and measurement devices with increased accuracy at lower torque values. Example implementations will primarily be described in the context of an electronic torque wrench. Other examples of suitable apparatuses for torque measurement include a torque tester, torque meter, torque transducer or the like. FIGS. 1A and 1B illustrate an electronic torque wrench 100 according to some example implementations of the present disclosure. As shown, the electronic torque wrench includes a wrench body 102, a wrench head 104 (e.g., a ratcheting wrench head), a grip handle 106, a housing 108, a battery assembly 110, and an electronics unit 112 with a user interface 114. In some examples, the wrench body is of tubular construction, made of steel or other rigid material, and receives the wrench head at a first end and the battery assembly at a second end, secured therein by an end cap 116. In some of these examples, the housing is mounted therebetween and carries the electronics unit.

As shown, a front end 118 of the wrench head 104 includes a coupler with a lever 120 that allows a user to select whether torque is applied to a fastener in either a clockwise (CW) or counter-clockwise (CCW) direction. A mechanism includes a boss 122 for receiving variously sized sockets, extensions, etc. A rear end 124 of the wrench head is slidably received in the wrench body 102 and rigidly secured therein. The wrench head includes at least one vertical flat portion 126 formed between the front end and the rear end for receiving a strain gauge assembly 128. The flat portion of the wrench head is both transverse to the plane of rotation of torque wrench 100 and parallel to the longitudinal center axis of the wrench head. The strain gauge assembly includes one or more strain gauges. In some examples, the strain gauge assembly is a full-bridge assembly including four separate strain gauges on a single film that is secured to the flat portion of the wrench head. Together, the full-bridge strain gauge assembly mounted on the flat portion of the wrench head is referred to as a strain tensor.

As also shown, the housing 108 includes a bottom portion 130 that is slidably received about the wrench body 104 and defines an aperture 132 for receiving a top portion 134 that carries the electronics unit 112. The electronics unit provides the user interface 114 for the operation of the electronic torque wrench 100. The electronics unit includes a circuit board 136 including a digital display 138 and an annunciator 140 mounted thereon. The portion of the housing defines an aperture that receives the user interface, which includes a power button 142, a unit selection button 144, increment/decrement buttons 146A and 146B, and three light emitting diodes (LEDs) 148A, 148B and 148C. And the LEDs may illuminate green, yellow and red, respectively, when activated.

FIG. 2 illustrates an apparatus 200 for determining a torque value of an applied torque, according to some example implementations. The apparatus may be embodied in a number of different manners, and in some examples, the apparatus is an electronic torque wrench such as electronic torque wrench 100. In other examples, the apparatus is a torque tester, torque meter, torque transducer or the like. As shown, the apparatus includes a strain gauge assembly 202 (e.g., strain gauge assembly 128), an amplifier 204, an analog-to-digital converter (ADC) 206, and processing circuitry 208. In some examples in which the apparatus 200 corresponds to electronic torque wrench 100, the amplifier ADC and processing circuitry may be components of the electronics unit 112, carried by the circuit board 136.

The strain gauge assembly 202 is configured to measure an applied torque such as the torque applied to a fastener when the apparatus 200 is an electronic torque wrench, and produce an analog electrical signal that varies in voltage with the torque. The amplifier 204 is configured to receive the analog electrical signal, and increase an amplitude of the analog electrical signal to produce an amplified, analog electrical signal. The amplifier has a gain that is controllable and set based on a measured torque, such as by an external signal from the processing circuitry 208. Examples of a suitable amplifier include a programmable-gain amplifier (PGA), a variable-gain amplifier (VGA) or the like.

The ADC 206 is configured to convert the amplified, analog electrical signal to an equivalent digital electrical signal. The processing circuitry 208, then, is configured to determine the torque value of the torque applied to the fastener from the equivalent digital electrical signal, and output an indication of the torque value. In some examples, the equivalent digital electrical signal includes digital data points; and in some of these examples, the processing circuitry is configured to determine a subset of the digital data points in a moving sample window, and calculate the torque value from a rolling average of the subset of the digital data points in the moving sample window.

To further illustrate use of the rolling average, consider an example in which the processing circuitry 208 samples one thousand digital data points per second and uses a moving sample window of ten milliseconds. As torque is applied, the processing circuitry may average the first ten digital data points, one taken each millisecond, thereby producing a first equivalent digital value at time t=0.01 seconds, wherein t=0.0 seconds marks initiation of the torquing operation. At time t=0.011 seconds, the processing circuitry may average the digital data points taken between times t=0.002 and t=0.011 seconds, thereby producing a second equivalent digital value. At time t=0.012 seconds, the processing circuitry may average the digital data points taken between times t=0.003 seconds and t=0.012 seconds, thereby producing a third equivalent digital value. And this may continue such that an equivalent digital value may be provided every millisecond until the torque is no longer applied. In short, the processing circuitry may utilize a digital filtering algorithm to provide a rolling average in which the oldest digital data point is dropped each time a new digital data point is received within the moving sample window.

The processing circuitry 208 may output the indication of the torque value in a number of different manners. In some examples, the apparatus 200 further includes a digital display 210 (e.g., digital display 138), and the processing circuitry is configured to output the indication of the torque value to the digital display that is configured to display the torque value.

The measured torque may be set or otherwise established in a number of different manners. In some examples, the apparatus 200 further includes a user interface 212 (e.g., user interface 114) by which the processing circuitry 208 is configured to receive user input by which the processing circuitry is configured to set the measured torque. Additionally or alternatively, in some examples, the strain gauge assembly 202 configured to measure the torque includes the strain gauge assembly configured to provide the measured torque.

As suggested above, in some examples, the processing circuitry 208 is configured to set the gain of the amplifier 204 based on the measured torque. In some of these examples, the gain set to a higher value when the measured torque lies at a lower end of a range of torque values, relative to when the measured torque lies at an upper end of the range. In some further examples, the lower end of the range is below a rated torque range of the apparatus 200, and the upper end of the range is within the rated torque range. In particular, the gain of the amplifier may be set above a predefined gain value gain when the measured torque is below the rated torque range, and set to gain when the measured torque is within the rated torque range. In various examples, this predefined gain value may be gain=1, although it should be understood that gain may be equally set to any of a number of different values.

In some even further examples, below the rated torque range includes a first subrange of torque values, and a second subrange of torque values that are greater than the torque values of the first subrange. And in some of these examples, the gain of the amplifier 204 is set to a first value above gain when the measured torque lies within the first subrange, and set to a lower, second value above gain when the measured torque lies within the second subrange.

To further illustrate how the gain of the amplifier 204 may be set, consider an apparatus 200 having a rated torque range of 20% to 100% of a preset maximum torque (e.g., 100 N·m). In the case of this apparatus, the gain of the amplifier may be set above gain when the measured torque is below 20% of the preset maximum torque (e.g., 20 N·m), and set to gain when the measured torque is within the rated torque range (e.g., 20 to 100 N·m). In further examples, consider that below the rated torque range includes a first subrange of torque values of 0.8 to 4.0% of the preset maximum toque, and a second subrange of torque values of 4 to 20% of the preset maximum torque. In these further examples, the gain of the amplifier may be set to 25×gain (e.g., 25 when gain=1) when the measured torque lies within the first subrange (e.g., 0.8 to 4 N·m), and set to 5×gain (e.g., 5 when gain=1) when the measured torque lies within the second subrange (e.g., 4 to 20 N·m).

In some examples, the processing circuitry 208 is configured to determine the torque value further from a calibration function that maps the equivalent digital electrical signal to the torque value. Any number of different calibration functions may be employed. In some examples, the gain of the amplifier 204 is set to a value from a plurality of predefined gain values, and the calibration function is a linear function selected from a plurality of linear functions for respective ones of the plurality of predefined gain values. In some of these examples, the plurality of linear functions include respective line segments for respective intervals of torque values over which the gain of the amplifier is set to respective ones of the plurality of predefined gain values.

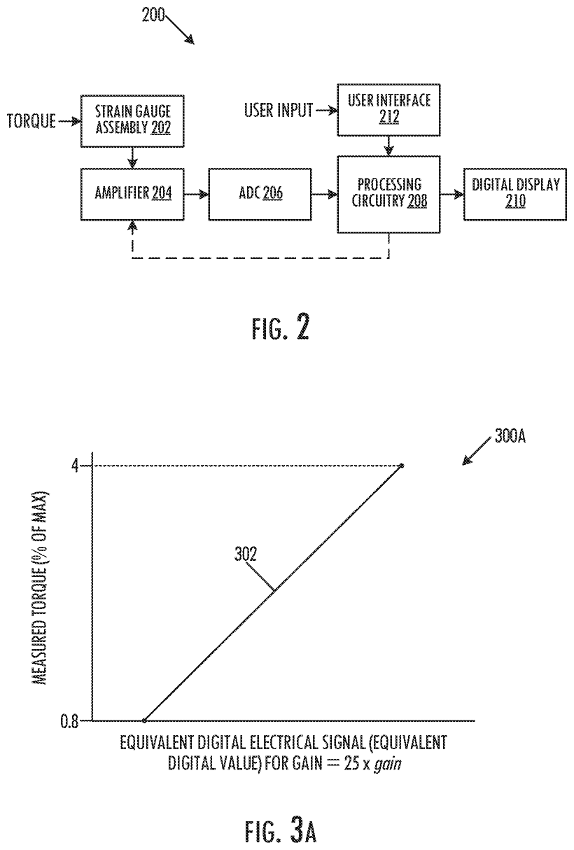

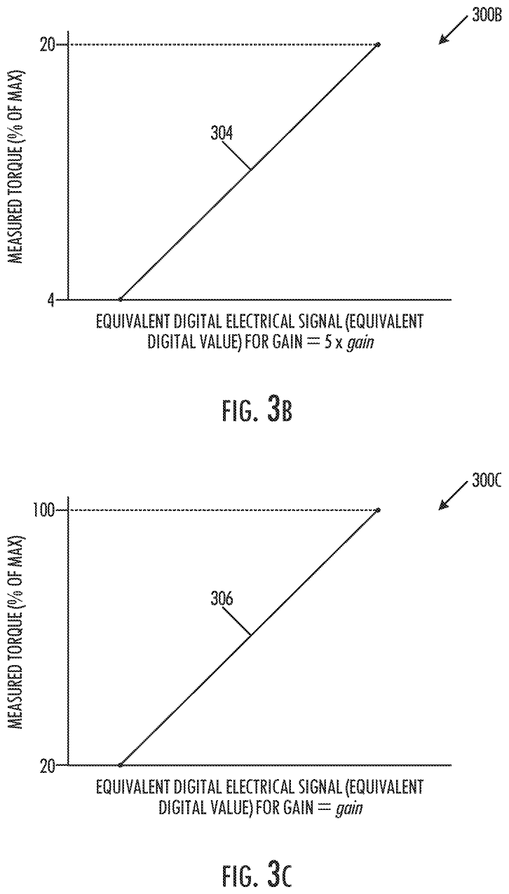

FIGS. 3A, 3B and 3C are graphs 300A, 300B, 300C of a plurality of linear functions from which the calibration function may be selected for use by the processing circuitry 208 to convert the digital values of the equivalent digital electrical signals into equivalent torque values, according to some example implementations. The graphs in FIGS. 3A, 3B and 3C continue the above example of the apparatus with a rated torque range of 20% to 100% of the preset maximum torque, and in which the gain of the amplifier 204 may be set to predefined gain values of 25×gain, 5×gain, or gain (e.g., 25, 5, 1).

After assembly, each apparatus 200 may be calibrated in order to derive the plurality of linear functions. The apparatus may be used to measure known applied torque values at various points along respective intervals of torque values for respective ones of the predefined gain values, the respective intervals ranging from 0 to 100% of the preset maximum torque. For the graph 300A, the points may be at 0.8% and 4% of the preset maximum torque for the interval 0.8 to 4.0% of the preset maximum torque (for gain 25). For the graph 300B, the points may be at 4% and 20% of the preset maximum torque for the interval 4 to 20% of the preset maximum torque (for gain 5). And for graph 300C, the points may be at 20% and 100% of the preset maximum torque for the interval 20 to 100% of the preset maximum torque (for gain 1).

The data points for the respective predefined gain values and intervals of torque values provide three different line segments (302, 304 and 306) of the graphs of which the slopes (m) and y-intercepts (b) can be found using the equation y=m(x)+b. The linear functions for the line segments may be stored in memory and used by the processing circuitry to determine equivalent torque values based on the received equivalent digital values, and the value of the predefined gain values to which the gain of the amplifier 204 is set.

In some examples in which the measured torque is provided by the strain gauge assembly 202, the processing circuitry 208 is configured to initially set the gain of the amplifier 204 to a default gain value such as 25. The strain gauge assembly 202 is configured to measure the torque applied to a fastener, and produce an analog signal that is passed through the amplifier and converted by the ADC 206 to an equivalent digital electrical signal, as described above. The processing circuitry may then divide digital values of the equivalent digital electrical signals by the default gain value to obtain the measured torque. The processing circuitry may set the gain of the amplifier to 25 when the measured torque is 0.8 to 4.0% of the preset maximum toque, set the gain of the amplifier to 5 when the measured torque is 4 to 20% of the preset maximum toque, and set the gain of the amplifier to 1 when the measured torque is 20 to 100% of the preset maximum toque.

Returning to FIG. 2, the processing circuitry 208 of example implementations of the present disclosure may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In more particular examples, the processing circuitry may be embodied as or include a processor, coprocessor, controller, microprocessor, microcontroller, application specific integrated circuit (ASIC), field programmable gate array (FPGA) or the like.

The digital display 210 is generally any display device configured to present information in visual or tactile form. Examples of suitable digital displays include a electroluminescent (EL) display, liquid crystal display (LCD), light-emitting diode display (LED), plasma (P) display, quantum dot (QD) display and the like.

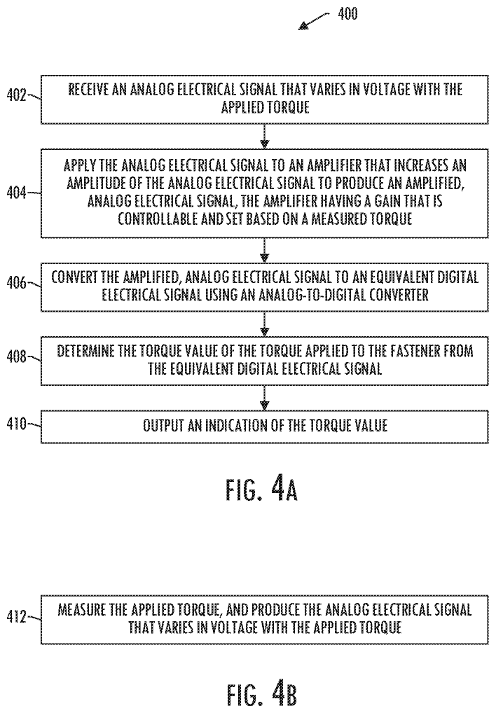

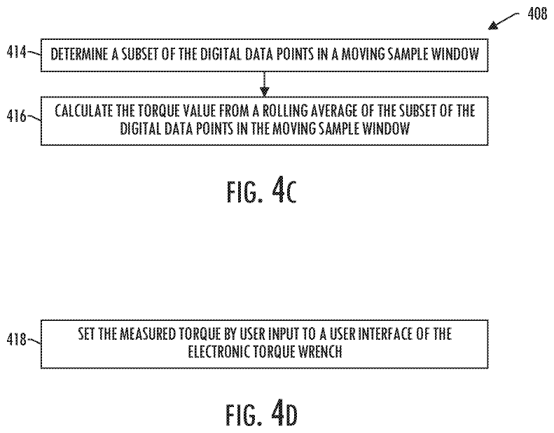

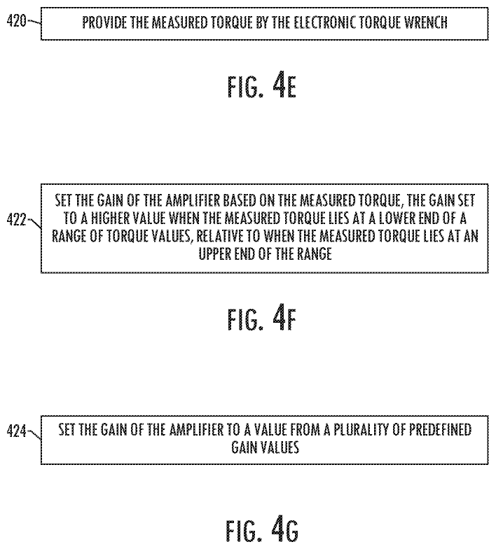

FIGS. 4A-4G are flowcharts illustrating various steps in a method 400 of determining a torque value of an applied torque, according to various example implementations of the present disclosure. The method includes receiving an analog electrical signal that varies in voltage with the applied torque, as shown at block 402 of FIG. 4A. The method includes applying the analog electrical signal to an amplifier that increases an amplitude of the analog electrical signal to produce an amplified, analog electrical signal, the amplifier having a gain that is controllable and set based on a measured torque, as shown at block 404. The method includes converting the amplified, analog electrical signal to an equivalent digital electrical signal using an analog-to-digital converter, as shown at block 406. And the method includes determining the torque value of the torque applied to the fastener from the equivalent digital electrical signal, as shown at block 408. And the method includes outputting an indication of the torque value, as shown at block 410.

In some examples, the method 400 further includes measuring the applied toque, and producing the analog electrical signal that varies in voltage with the applied torque, as shown at block 412 of FIG. 4B.

In some examples, the analog electrical signal is applied at block 404 to the amplifier that is a programmable-gain amplifier (PGA) or a variable-gain amplifier (VGA).

In some examples, the equivalent digital electrical signal includes digital data points, and determining the torque value at block 408 includes determining a subset of the digital data points in a moving sample window, as shown at block 414 of FIG. 4C. And the method includes calculating the torque value from a rolling average of the subset of the digital data points in the moving sample window, as shown at block 416.

In some examples, the indication of the torque value is output at block 410 to a digital display that displays the torque value.

In some examples, the applied torque is by an electronic torque wrench, and the method 400 further includes setting the measured torque by user input to a user interface of the electronic torque wrench, as shown at block 418 of FIG. 4D.

In some examples, the applied torque is by an electronic torque wrench, and the method 400 further includes providing the measured torque by the electronic torque wrench, as shown at block 420 of FIG. 4E.

In some examples, the method 400 further includes setting the gain of the amplifier based on the measured torque, the gain set to a higher value when the measured torque lies at a lower end of a range of torque values, relative to when the measured torque lies at an upper end of the range, as shown at block 422 of FIG. 4F.

In some examples, the applied torque is by an electronic torque wrench, the lower end of the range is below a rated torque range of the electronic torque wrench, and the upper end of the range is within the rated torque range.

In some examples, the gain of the amplifier is set above a predefined gain value gain at block 422 when the measured torque is below the rated torque range, and set to gain when the measured torque is within the rated torque range.

In some examples, below the rated torque range includes a first subrange of torque values, and a second subrange of torque values that are greater than the torque values of the first subrange. In some of these examples, the gain of the amplifier is set to a first value above gain at block 422 when the measured torque lies within the first subrange, and set to a lower, second value above gain when the measured torque lies within the second subrange.

In some examples, the torque value is determined at block 408 further from a calibration function that maps the equivalent digital electrical signal to the torque value.

In some examples, the method 400 further comprises setting the gain of the amplifier to a value from a plurality of predefined gain values, as shown at block 424 of FIG. 4G. In some of these examples, the calibration function is a linear function selected from a plurality of linear functions for respective ones of the plurality of predefined gain values, and the plurality of linear functions include respective line segments for respective intervals of torque values over which the gain of the amplifier is set to respective ones of the plurality of predefined gain values.

As explained above and reiterated below, the present disclosure includes, without limitation, the following example implementations.

Clause 1. An apparatus for determining a torque value of an applied torque, the apparatus comprising: an amplifier configured to receive an analog electrical signal that varies in voltage with the applied torque, and increase an amplitude of the analog electrical signal to produce an amplified, analog electrical signal, the amplifier having a gain that is controllable and set based on a measured torque; an analog-to-digital converter configured to convert the amplified, analog electrical signal to an equivalent digital electrical signal; and processing circuitry configured to determine the torque value of the torque applied to the fastener from the equivalent digital electrical signal, and output an indication of the torque value.

Clause 2. The apparatus of clause 1, wherein the apparatus is an electronic torque wrench, torque tester, torque meter or torque transducer.

Clause 3. The apparatus of clause 1 or clause 2, wherein the apparatus further comprises: a strain gauge assembly configured to measure the applied torque, and produce the analog electrical signal that varies in voltage with the applied torque.

Clause 4. The apparatus of any of clauses 1 to 3, wherein the amplifier is a programmable-gain amplifier (PGA) or a variable-gain amplifier (VGA).

Clause 5. The apparatus of any of clauses 1 to 4, wherein the equivalent digital electrical signal includes digital data points, and the processing circuitry configured to determine the torque value includes the processing circuitry configured to: determine a subset of the digital data points in a moving sample window; and calculate the torque value from a rolling average of the subset of the digital data points in the moving sample window.

Clause 6. The apparatus of any of clauses 1 to 5, wherein the apparatus further comprises a digital display, and the processing circuitry is configured to output the indication of the torque value to the digital display that is configured to display the torque value.

Clause 7. The apparatus of any of clauses 1 to 6, wherein the apparatus further comprises a user interface by which the processing circuitry is configured to receive user input by which the processing circuitry is configured to set the measured torque.

Clause 8. The apparatus of any of clauses 1 to 7, wherein the strain gauge assembly configured to measure the torque includes the strain gauge assembly configured to provide the measured torque.

Clause 9. The apparatus of any of clauses 1 to 8, wherein the processing circuitry is configured to set the gain of the amplifier based on the measured torque, the gain set to a higher value when the measured torque lies at a lower end of a range of torque values, relative to when the measured torque lies at an upper end of the range.

Clause 10. The apparatus of clause 9, wherein the lower end of the range is below a rated torque range of the apparatus, and the upper end of the range is within the rated torque range.

Clause 11. The apparatus of clause 10, wherein the gain of the amplifier is set above a predefined gain value gain when the measured torque is below the rated torque range, and set to gain when the measured torque is within the rated torque range.

Clause 12. The apparatus of clause 11, wherein below the rated torque range includes a first subrange of torque values, and a second subrange of torque values that are greater than the torque values of the first subrange, and wherein the gain of the amplifier is set to a first value above gain when the measured torque lies within the first subrange, and set to a lower, second value above gain when the measured torque lies within the second subrange.

Clause 13. The apparatus of any of clauses 1 to 12, wherein the processing circuitry is configured to determine the torque value further from a calibration function that maps the equivalent digital electrical signal to the torque value.

Clause 14. The apparatus of clause 13, wherein the processing circuitry is configured to set the gain of the amplifier to a value from a plurality of predefined gain values, and wherein the calibration function is a linear function selected from a plurality of linear functions for respective ones of the plurality of predefined gain values, and the plurality of linear functions include respective line segments for respective intervals of torque values over which the gain of the amplifier is set to respective ones of the plurality of predefined gain values.

Clause 15. A method of determining a torque value of an applied torque, the method comprising: receiving an analog electrical signal that varies in voltage with the applied torque; applying the analog electrical signal to an amplifier that increases an amplitude of the analog electrical signal to produce an amplified, analog electrical signal, the amplifier having a gain that is controllable and set based on a measured torque; converting the amplified, analog electrical signal to an equivalent digital electrical signal using an analog-to-digital converter; and determining the torque value of the torque applied to the fastener from the equivalent digital electrical signal; and outputting an indication of the torque value.

Clause 16. The method of clause 15, wherein the method further comprises: measuring the applied torque, and producing the analog electrical signal that varies in voltage with the applied torque.

Clause 17. The method of clause 15 or clause 16, wherein the analog electrical signal is applied to the amplifier that is a programmable-gain amplifier (PGA) or a variable-gain amplifier (VGA).

Clause 18. The method of any of clauses 15 to 17, wherein the equivalent digital electrical signal includes digital data points, and determining the torque value includes: determining a subset of the digital data points in a moving sample window; and calculating the torque value from a rolling average of the subset of the digital data points in the moving sample window.

Clause 19. The method of any of clauses 15 to 18, wherein the indication of the torque value is output to a digital display that displays the torque value.

Clause 20. The method of any of clauses 15 to 19, wherein the applied torque is by an electronic torque wrench, and the method further comprises setting the measured torque by user input to a user interface of the electronic torque wrench.

Clause 21. The method of any of clauses 15 to 20, wherein the applied torque is by an electronic torque wrench, and the method further comprises providing the measured torque by the electronic torque wrench.

Clause 22. The method of any of clauses 15 to 21, wherein the method further comprises setting the gain of the amplifier based on the measured torque, the gain set to a higher value when the measured torque lies at a lower end of a range of torque values, relative to when the measured torque lies at an upper end of the range.

Clause 23. The method of clause 22, wherein the applied torque is by an electronic torque wrench, the lower end of the range is below a rated torque range of the electronic torque wrench, and the upper end of the range is within the rated torque range.

Clause 24. The method of clause 23, wherein the gain of the amplifier is set above a predefined gain value gain when the measured torque is below the rated torque range, and set to gain when the measured torque is within the rated torque range.

Clause 25. The method of clause 24, wherein below the rated torque range includes a first subrange of torque values, and a second subrange of torque values that are greater than the torque values of the first subrange, and wherein the gain of the amplifier is set to a first value above gain when the measured torque lies within the first subrange, and set to a lower, second value above gain when the measured torque lies within the second subrange.

Clause 26. The method of any of clauses 15 to 25, wherein the torque value is determined further from a calibration function that maps the equivalent digital electrical signal to the torque value.

Clause 27. The method of clause 26, wherein the method further comprises setting the gain of the amplifier to a value from a plurality of predefined gain values, and wherein the calibration function is a linear function selected from a plurality of linear functions for respective ones of the plurality of predefined gain values, and the plurality of linear functions include respective line segments for respective intervals of torque values over which the gain of the amplifier is set to respective ones of the plurality of predefined gain values.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for determining a torque value of an applied torque, the apparatus comprising:
an amplifier configured to receive an analog electrical signal that varies in voltage with the applied torque, and increase an amplitude of the analog electrical signal to produce an amplified, analog electrical signal, the amplifier having a gain that is controllable and set based on a measured torque;
an analog-to-digital converter configured to convert the amplified, analog electrical signal to an equivalent digital electrical signal; and
processing circuitry configured to determine the torque value of the torque applied to the fastener from the equivalent digital electrical signal, and output an indication of the torque value.

2. The apparatus of claim 1, wherein the apparatus is an electronic torque wrench, torque tester, torque meter or torque transducer.

3. The apparatus of claim 1, wherein the apparatus further comprises:
a strain gauge assembly configured to measure the applied torque, and produce the analog electrical signal that varies in voltage with the applied torque.

4. The apparatus of claim 1, wherein the amplifier is a programmable-gain amplifier (PGA) or a variable-gain amplifier (VGA).

5. The apparatus of claim 1, wherein the equivalent digital electrical signal includes digital data points, and the processing circuitry configured to determine the torque value includes the processing circuitry configured to:
determine a subset of the digital data points in a moving sample window; and
calculate the torque value from a rolling average of the subset of the digital data points in the moving sample window.

6. The apparatus of claim 1, wherein the apparatus further comprises a digital display, and the processing circuitry is configured to output the indication of the torque value to the digital display that is configured to display the torque value.

7. The apparatus of claim 1, wherein the processing circuitry is configured to set the gain of the amplifier based on the measured torque, the gain set to a higher value when the measured torque lies at a lower end of a range of torque values, relative to when the measured torque lies at an upper end of the range.

8. The apparatus of claim 7, wherein the lower end of the range is below a rated torque range of the apparatus, and the upper end of the range is within the rated torque range.

9. The apparatus of claim 8, wherein the gain of the amplifier is set above a predefined gain value gain when the measured torque is below the rated torque range, and set to gain when the measured torque is within the rated torque range.

10. The apparatus of claim 9, wherein below the rated torque range includes a first subrange of torque values, and a second subrange of torque values that are greater than the torque values of the first subrange, and
wherein the gain of the amplifier is set to a first value above gain when the measured torque lies within the first subrange, and set to a lower, second value above gain when the measured torque lies within the second subrange.

11. The apparatus of claim 1, wherein the processing circuitry is configured to determine the torque value further from a calibration function that maps the equivalent digital electrical signal to the torque value.

12. The apparatus of claim 11, wherein the processing circuitry is configured to set the gain of the amplifier to a value from a plurality of predefined gain values, and
wherein the calibration function is a linear function selected from a plurality of linear functions for respective ones of the plurality of predefined gain values, and the plurality of linear functions include respective line segments for respective intervals of torque values over which the gain of the amplifier is set to respective ones of the plurality of predefined gain values.

13. A method of determining a torque value of an applied torque, the method comprising:
receiving an analog electrical signal that varies in voltage with the applied torque;
applying the analog electrical signal to an amplifier that increases an amplitude of the analog electrical signal to produce an amplified, analog electrical signal, the amplifier having a gain that is controllable and set based on a measured torque;
converting the amplified, analog electrical signal to an equivalent digital electrical signal using an analog-to-digital converter; and
determining the torque value of the torque applied to the fastener from the equivalent digital electrical signal; and
outputting an indication of the torque value.

14. The method of claim 13, wherein the method further comprises:
measuring the applied torque, and producing the analog electrical signal that varies in voltage with the applied torque.

15. The method of claim 13, wherein the analog electrical signal is applied to the amplifier that is a programmable-gain amplifier (PGA) or a variable-gain amplifier (VGA).

16. The method of claim 13, wherein the equivalent digital electrical signal includes digital data points, and determining the torque value includes:
determining a subset of the digital data points in a moving sample window; and
calculating the torque value from a rolling average of the subset of the digital data points in the moving sample window.

17. The method of claim 13, wherein the indication of the torque value is output to a digital display that displays the torque value.

18. The method of claim 13, wherein the method further comprises setting the gain of the amplifier based on the measured torque, the gain set to a higher value when the measured torque lies at a lower end of a range of torque values, relative to when the measured torque lies at an upper end of the range.

19. The method of claim 18, wherein the applied torque is by an electronic torque wrench, the lower end of the range is below a rated torque range of the electronic torque wrench, and the upper end of the range is within the rated torque range.

20. The method of claim 19, wherein the gain of the amplifier is set above a predefined gain value gain when the measured torque is below the rated torque range, and set to gain when the measured torque is within the rated torque range.

21. The method of claim 20, wherein below the rated torque range includes a first subrange of torque values, and a second subrange of torque values that are greater than the torque values of the first subrange, and
wherein the gain of the amplifier is set to a first value above gain when the measured torque lies within the first subrange, and set to a lower, second value above gain when the measured torque lies within the second subrange.

22. The method of claim 13, wherein the torque value is determined further from a calibration function that maps the equivalent digital electrical signal to the torque value.

23. The method of claim 22, wherein the method further comprises setting the gain of the amplifier to a value from a plurality of predefined gain values, and
wherein the calibration function is a linear function selected from a plurality of linear functions for respective ones of the plurality of predefined gain values, and the plurality of linear functions include respective line segments for respective intervals of torque values over which the gain of the amplifier is set to respective ones of the plurality of predefined gain values.
